(19) United States
(12) Patent Application Publication
(10) Pub. No.: US 2011/0109802 A1
(43) Pub. Date: May 12, 2011

(54) VIDEO COMBINING SYSTEM AND METHOD

(75) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 12/637,642

(22) Filed: Dec. 14, 2009

(30) Foreign Application Priority Data
Nov. 12, 2009 (CN) 200910309622.1

(51) Int. Cl. H04N 9/74

(52) U.S. Cl. 348/584; 348/E09.055

(57) ABSTRACT

A video combining system includes a number of cameras, a startup module, and a combining module. The startup module starts the number of cameras in turn. The number of cameras captures a scene at different moments to obtain a number of images. The combining module chronologically combines the number of images to obtain a section of video. The section of video has a high frame rate.

### BACKGROUND

1. Technical Field

The present disclosure relates to a video combining system and a video combining method.

2. Description of Related Art

The frame rate, or the frame frequency, is a measurement of the frequency (rate) at which an imaging device produces unique consecutive images called frames. The frame rate is most often expressed in frames per second (FPS). Generally, 30 fps can satisfy viewer's requirement unless a need exists for greater detail and/or shooting fast moving subjects, which means that higher frame rate is needed. However, a single camera that has higher frame rates is often very expensive.

### BRIEF DESCRIPTION OF THE DRAWINGS

FIG. 1 is a schematic block diagram of a first exemplary embodiment of a video combining system including a storage system.

FIG. 2 is a schematic block diagram of the storage system of FIG. 1.

FIG. 3 is a flowchart of an exemplary embodiment of a video combining method.

### DETAILED DESCRIPTION

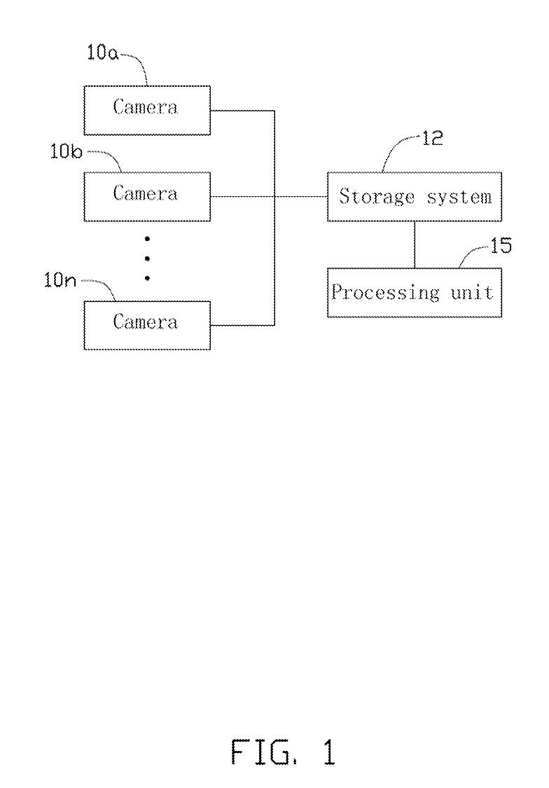

Referring to FIG. 1, an exemplary embodiment of a video combining system 1 includes a plurality of cameras 10a-10n, a storage system 12, and a processing unit 15. The video combining system 1 is operable to obtain a video with high frame rates.

The plurality of cameras 10a-10n capture a same scene to obtain a plurality of images of the scene.

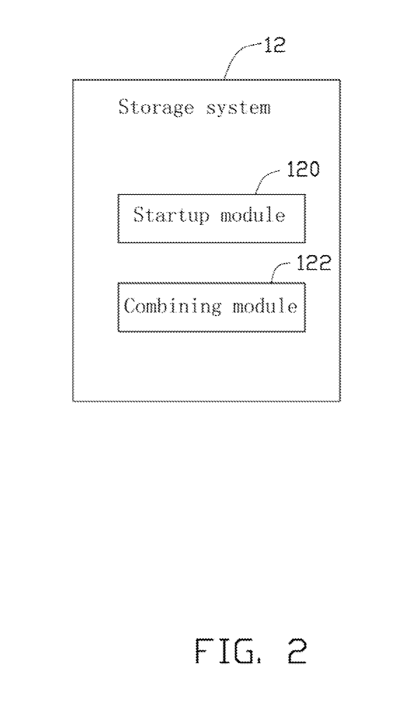

Referring to FIG. 2, the storage system 12 includes a startup module 120 and a combining module 122. The startup module 120 and the combining module 122 may include one or more computerized instructions and are executed by the processing unit 15.

The startup module 120 starts the plurality of cameras 10a-10n in turn. For example, after a first camera 10a is started, the startup module 120 starts a second camera 10b, and so forth. The plurality of cameras 10a-10n captures the same scene to obtain the plurality of images at different times.

The combining module 122 chronologically combines the plurality of images, to obtain a section of video. For example, in the section of video, a first image captured at a prior time is placed in front of a second image captured at a latter time.

Supposing that the video combining system 1 includes the first camera 10a and the second camera 10b. Each of the first camera 10a and the second camera 10b can capture the scene fifty times per second. In other words, each of the first camera 10a and the second camera 10b captures the scene twenty millisecond intervals. As a result, a section of video obtained from the first camera 10a or the second camera 10b has a frame rate of 50 frames per second (fps).

After the first camera 10a is started for ten milliseconds, the startup module 120 starts the second camera 10b. As a result, images are captured every ten milliseconds by the first and second cameras 10a, 10b alternating to obtain one hundred images in one second.

The combining module 122 chronologically combines the one hundred images, to obtain combined one second section of video with an fps of 100.

In other embodiments, the plurality of cameras 10a-10n may be time of flight (TOF) cameras. The TOF camera is a camera system that creates distance data between the scene to be captured and the TOF camera. As a result, users can remove some portions in the section of video not needed to obtain the data.

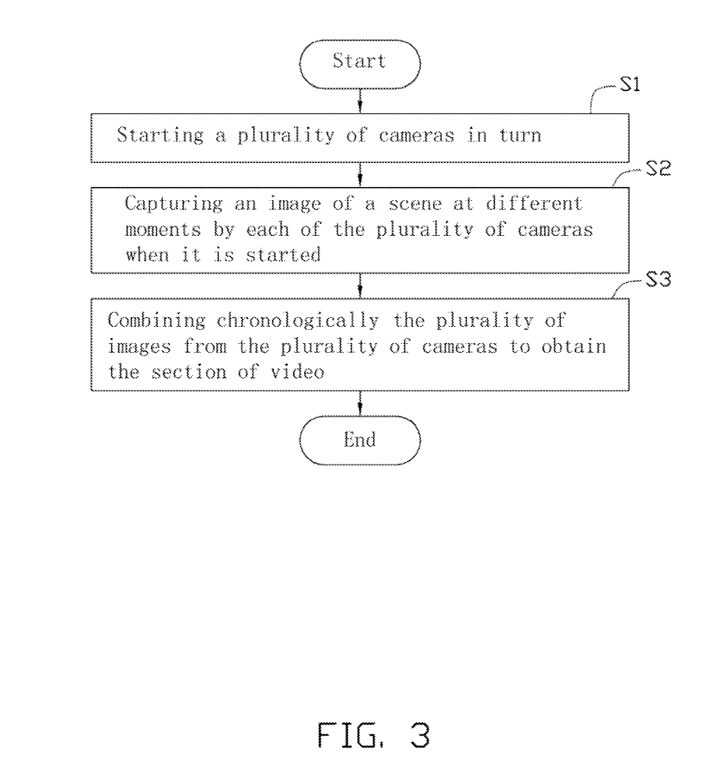

Referring to FIG. 3, an exemplary embodiment of a video combining method includes the following steps.

In step S1, the startup module 120 starts the plurality of cameras 10a-10n in turn. For example, after the first camera 10a is started for ten milliseconds, the startup module 120 starts the second camera 10b.

In step S2, the plurality of cameras 10a-10n captures the scene at different moments respectively. For example, the first camera 10a captures the scene at moments of zero millisecond, twenty milliseconds, forty milliseconds, sixty milliseconds, and so on, to obtain fifty images in one second. The second camera 10b captures the scene at moments of ten milliseconds, thirty milliseconds, fifty milliseconds, seventy milliseconds, and so on, to obtain fifty images in one second. In other words, images are captured every ten milliseconds by the first and second cameras 10a, 10b alternatingly to obtain one hundred images in one second.

In step S3, the combining module 22 chronologically combines the one hundred images from the first camera 10a and the second camera 10b, to obtain the combined one second section of video with an fps of 100.

The foregoing description of the exemplary embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A video combining system comprising:
a plurality of cameras;
a processing unit; and
a storage system connected to the processing unit and storing a plurality of modules to be executed by the processing unit, wherein the plurality of modules comprises:
a startup module to start the plurality of cameras in turn, wherein the plurality of cameras captures a scene at different moments to obtain a plurality of images; and
a combining module to chronologically combine the plurality of images to obtain a section of video.

2. The video combining system of claim 1, each of the plurality cameras is a time of flight camera.

3. A video combining method comprising:
starting a plurality of cameras in turn;
capturing a scene at different moments by the plurality of cameras at different moment, to obtain a plurality of images; and
combining the plurality of images chronologically to obtain a section of video.

4. The video combining method of claim 3, wherein each of the plurality of cameras is a time of flight camera.
